(19) United States
(12) Patent Application Publication
(10) Pub. No.: US 2023/0349016 A1
(43) Pub. Date: Nov. 2, 2023

(54) MELTING/REFINING FURNACE FOR COLD IRON SOURCES, AND MELTING/REFINING FURNACE OPERATION METHOD

(71) Applicant: TAIYO NIPPON SANSO CORPORATION, Tokyo (JP)

(72) Inventors: Masashi YAMAGUCHI, Tokyo (JP); Yasuyuki YAMAMOTO, Tokyo (JP); Yoshiyuki HAGIHARA, Tokyo (JP)

(21) Appl. No.: 17/921,249

(22) PCT Filed: Apr. 14, 2021
(86) PCT No.: PCT/JP2021/015385

§ 371 Date: Oct. 25, 2022

(30) Foreign Application Priority Data
Apr. 27, 2020 (JP) 2020-078412

(51) Int. Cl. C21C 5/52; C21C 5/46

(52) U.S. Cl. CPC C21C 5/5217; C21C 5/4673; C21C 5/4606; C21C 2005/5288

(57) ABSTRACT

The object of the present invention is to provide a melting/refining furnace for cold iron sources and an operation method for a melting/refining furnace that can increase the heating efficiency of the raw material without causing oxidation of the raw material, reduce the amount of power consumption required for melting the raw material, shorten the melting and refining time, improve the productivity, and reduce costs, and the present invention provides a melting/refining furnace including: one or more through-holes (21) provided to penetrate a furnace wall (2A) of an electric furnace (2); and an oxygen burner-lance (3) provided in the through-hole (21), wherein the oxygen burner-lance (3) includes at least one combustion-supporting gas supply pipe (31) and at least one fuel gas supply pipe (32) which have an opening communicating with an inside of the electric furnace (2), and wherein a high-temperature gas generator (10) is provided in any one or more of the combustion-supporting gas supply pipes (31).

### TECHNICAL FIELD

The present invention relates to a melting/refining furnace for cold iron sources, and an operation method for a melting/refining furnace.

### BACKGROUND ART

Conventionally, for example, a burner that generates a flame by a fuel gas and a combustion-supporting gas, such as oxygen-enriched air which is obtained by mixing oxygen with air, and oxygen, has been used for heating the interior of an industrial furnace.

For example, in electric furnace processes in the field of steelmaking, a burner is used to assist in heating and melting of a raw material including cold iron sources such as scrap iron in the electric furnace. In this way, by using a burner that generates a flame, the heating efficiency of the raw material can be increased, the power consumption for melting the raw material can be reduced, and the melting time can be shortened, making it possible to improve productivity and reduce costs.

As mentioned above, a technology that uses a burner for heating in the furnace, a melting/refining furnace including an oxygen burner-lance, a secondary combustion lance, a carbon supply source, a thermometer, and a discharged gas analyzer, and an operation method for the melting/refining furnace have been proposed (see, for example, Patent Document 1).

The secondary combustion adopted in Patent Document 1 generally means that CO and H₂, which are combustible gases discharged in an uncombusted state during the iron melting period, are combined with oxygen ejected from the secondary combustion lance to improve heat efficiency.

Further, the oxygen burner-lance provided with the melting/refining furnace of Patent Document 1 is mainly used as a heat source during the melting period, and is mainly used for component adjustment during the refining period. When supplying the carbon supply source to the furnace, an operation method of supplying the carbon supply source from the lower side of the oxygen burner-lance is mainly adopted.

Furthermore, Patent Document 1 proposes that the temperature in the furnace measured by a thermometer, a concentration of components of discharged gas measured by a discharged gas analyzer and a flow rate of discharged gas be analyzed, and an amount of a combustion-supporting gas, a fuel gas, and a carbon supply source supplied to the furnace be controlled by a flow rate control unit which is electrically connected to the thermometer and the discharged gas analyzer.

As another heating method for industrial furnaces, a method is known in which an oxidizing agent is used for combustion in a burner in order to improve heating efficiency and save energy. Specifically, it has been proposed to use an oxygen-enriched burner that uses oxygen enriched-air which is obtained by mixing oxygen with air, or an oxygen burner that uses oxygen. In addition, as a method of using an oxidant for combustion in a burner, for example, it has been proposed to obtain a high combustion temperature by using a preheated oxidant (see Patent Document 2, for example).

In addition, in the electric furnace using an oxygen burner-lance, a fuel gas and an oxidant are blown over a long distance in order to efficiently heat and melt the cold iron sources, so the ejection speed of each gas is supersonic. As a means for heating such an oxidant ejected at supersonic speed, for example, Patent Document 2 proposes a direct combustion method.

### PRIOR ART DOCUMENTS

### Patent Documents

Patent Document 1: Japanese Unexamined Patent Application, First Publication No. 2017-179574
Patent Document 2: Published Japanese Translation No. 2011-526998 of the PCT international Publication SUMMARY OF INVENTION

### Problem to be Solved by the Invention

The technology disclosed in Patent Document 1 aims to improve the total energy efficiency of the furnace by optimally controlling the amount of the combustion-supporting gas, the fuel gas, and the carbon supply source supplied, as described above. In Patent Document 1, when the temperature in the furnace is determined to be low, the oxygen burner-lance is operated. Also, when CO and H₂ are discharged, the combustion-supporting gas containing oxygen for secondary combustion is introduced to the furnace.

However, as disclosed in Patent Document 1, when a large amount of oxygen is supplied to the furnace, the heating and melting of iron is accelerated, but the oxidation of molten steel progresses, and it takes time to adjust the composition thereafter. As a result, the amount of electricity used in the entire process increases, and the amount of the carbon supply source used increases, resulting in a problem of reduced energy efficiency.

In addition, in the technology disclosed in Patent Document 1, the problem of decreasing the energy efficiency described above is improved to some extent by controlling the amount of the combustion-supporting gas, the fuel gas, and the carbon supply source supplied based on the temperature in the furnace and the results of the discharged gas analyzer. However, due to the quality of the raw material cold iron sources and the characteristics of the furnace, it is difficult to achieve both promotion of melting by supplying the combustion-supporting gas and suppression of peroxidation by limiting the amount of the combustion-supporting gas supplied. Efforts to prevent such a decrease in energy efficiency have remained extremely limited.

The present invention has been made in view of the above problems, and an object of the present invention is to provide a melting/refining furnace for cold iron sources and an operation method for a melting/refining furnace that can increase the heating efficiency of the raw material without causing oxidation of the raw material, reduce the amount of power consumption required for melting the raw material, shorten the melting and refining time, improve the productivity, and reduce costs.

### Means for Solving the Problem

In order to solve the above problems, the present invention provides the following melting/refining furnace for cold iron sources and the operation method of a melting/refining furnace.

[1] A melting/refining furnace including an oxygen burner-lance for ejecting a combustion-supporting gas containing oxygen and a fuel gas toward cold iron sources in the furnace,
wherein the melting/refining furnace includes:
one or more through-holes provided to penetrate a furnace wall; and an oxygen burner-lance provided in the through-hole,
wherein the oxygen burner-lance includes at least one combustion-supporting gas supply pipe having an opening communicating with an inside of the furnace and at least one fuel gas supply pipe having an opening communicating with an inside of the furnace, and
wherein a high-temperature gas generator is provided in any one or more of the combustion-supporting gas supply pipes.

[2] The melting/refining furnace according to [1],
wherein the high-temperature gas generator includes:
a burner in which a high-temperature combustion-supporting gas is produced by mixing a high-temperature gas and a gas to be heated, the high-temperature combustion-supporting gas produced is supplied to the oxygen burner-lance as a combustion-supporting gas, and a high temperature gas is produced; and
a pre-heating chamber which is provided downstream of the burner in a flow direction of a gas ejected from the burner and mixes the high-temperature gas and the gas to be heated,
wherein the burner includes:
a combustion chamber in which a flame is produced by the fuel gas and the combustion-supporting gas;
a fuel flow path that supplies the fuel gas to the combustion chamber;
a combustion-supporting gas flow path that supplies the combustion-supporting gas to the combustion chamber; and
a gas to be heated flow path which communicates with the pre-heating chamber and supplies the gas to be heated toward the pre-heating chamber.

[3] The melting/refining furnace according to [2],
wherein the high-temperature gas generator further includes a cooling jacket which cools the burner or both the burner and the pre-heating chamber.

[4] The melting/refining furnace according to [2] or [3],
wherein the melting/refining furnace further includes:
a thermometer that measures the temperature in the furnace; and
a flow control unit that is electrically connected to the thermometer, and based on the temperature in the furnace measured by the thermometer, controls an amount of the combustion-supporting gas and the fuel gas supplied to the oxygen burner-lance, and an amount of the fuel gas, the combustion-supporting gas, and the gas to be heated to the high-temperature gas generator.

[5] The melting/refining furnace according to [2] or [3],
wherein the melting/refining furnace further includes:
a discharge passage which discharges a discharged gas from inside of the furnace;
a discharged gas analyzer which is provided in the discharge passage for discharged gas and measures at least one of a concentration of components contained in the discharged gas and the flow rate of the discharged gas;
a discharged gas thermometer which is provided in the discharge passage for discharged gas downstream of the discharged gas analyzer in a flow direction of the discharged gas and measures the temperature of the discharged gas; and
a flow rate control unit which receives a measured value of the temperature of the discharged gas from the discharged gas thermometer, and a measured value of the concentration of components and the flow rate of the discharged gas from the discharged gas analyzer, analyzes these measured values, and controls an amount of the combustion-supporting gas and the fuel gas supplied to the oxygen burner-lance and an amount of the fuel gas, the combustion-supporting gas, and the gas to be heated to the high-temperature gas generator.

[6] The melting/refining furnace according to any one of [1] to [5],
wherein the combustion-supporting gas is oxygen gas or oxygen-enriched air.

[7] The melting/refining furnace according to any one of [2] to [6],
wherein the gas to be heated supplied to the high-temperature gas generator is oxygen gas.

[8] An operation method of a melting/refining furnace in which a combustion-supporting gas containing oxygen and a fuel gas are ejected toward cold iron sources in the furnace using an oxygen burner-lance, and the cold iron sources are melted and refined,
wherein the operation method includes:
a step in which a combustion-supporting gas is heated to a high temperature by a high-temperature gas generator provided in a combustion-supporting gas supply pipe in an oxygen burner-lance to obtain a high-temperature combustion-supporting gas; a step in which the high-temperature combustion-supporting gas is ejected toward the cold iron sources in the furnace as a combustion-supporting gas; and
a step in which, based on a measured temperature in the furnace, an amount of the combustion-supporting gas and the fuel gas supplied to the oxygen burner-lance is controlled, and combustion of the oxygen burner-lance is started and stopped.

[9] An operation method of a melting/refining furnace in which a combustion-supporting gas containing oxygen and a fuel gas are ejected toward cold iron sources in the furnace using an oxygen burner-lance, and the cold iron sources are melted and refined,
wherein the operation method includes:
a step in which a combustion-supporting gas is heated to a high temperature by a high-temperature gas generator provided in a combustion-supporting gas supply pipe of an oxygen burner-lance to obtain a high-temperature combustion-supporting gas;
a step in which the high-temperature combustion-supporting gas is ejected toward the cold iron sources in the furnace as a combustion-supporting gas; and
a step in which, based on measured values of a temperature of a discharged gas discharged from inside of the furnace, the concentration of components contained in the discharged gas, and the flow rate of the discharged gas, an amount of the combustion-supporting gas and the fuel gas supplied to the oxygen burner-lance, and an amount of the fuel gas, the combustion-supporting gas and a gas to be heated to the high-temperature gas generator are controlled, and the combustion of the oxygen burner-lance is started and stopped.

### Effects of the Invention

According to the melting/refining furnace of the present invention, since the melting/refining furnace includes the high-temperature gas generator in the combustion-supporting gas supply pipe in the oxygen burner-lance, the combustion-supporting gas supplied in the furnace is heated by the high-temperature gas. In this way, by supplying the high-temperature combustion-supporting gas heated by the high-temperature gas generator to the furnace, the cold iron sources can be efficiently heated without increasing the amount of the combustion-supporting gas supplied, and melted and refined.

Therefore, it is possible to prevent the oxidation of the raw material and to increase the heating efficiency of the raw material, making it possible to reduce the power consumption required for melting the raw material while shortening the melting and refining time, improving the productivity, and reducing the costs.

In addition, according to the operation method for a melting/refining furnace of the present invention, as explained above, by heating the combustion-supporting gas to a high temperature and ejecting it toward the cold iron sources in the furnace to melt and refine the cold iron sources, and controlling the amount of the combustion-supporting gas and the fuel gas supplied to the oxygen burner-lance based on the measured temperature in the furnace, and starting or stopping the combustion of the oxygen burner-lance, it is possible to heat efficiently the cold iron sources to melt and refine without increasing the amount of the combustion-supporting gas supplied.

In addition, it is possible to melt and refine the cold iron sources more efficiently depending on the conditions in the furnace by controlling the amount of combustion-supporting gas and fuel gas supplied and starting or stopping the combustion based on the measured value of the temperature inside the furnace.

Therefore, similar to the melting/refining furnace above, it is possible to achieve both prevention of oxidation of the raw material and enhancement of the heating efficiency of the raw material. As a result, it is possible to shorten the time required for melting and refining while reducing the amount of power used to melt the raw materials, thereby improving the productivity and reducing the costs.

### BRIEF DESCRIPTION OF DRAWINGS

FIG. 1 is a diagram schematically illustrating the configuration of a melting/refining furnace in an embodiment of the present invention, and is a system diagram showing an example of each gas flow path.

FIG. 2 is a diagram schematically illustrating the configuration of a melting/refining furnace in an embodiment of the present invention, and is a cross-sectional view showing the structure of a high-temperature gas generator.

FIG. 3 is a diagram schematically illustrating the configuration of a melting/refining furnace in an embodiment of the present invention, and is a system diagram showing another example of each gas flow path.

FIG. 4 is a diagram illustrating the effect of heating a combustion-supporting gas to a high temperature and supplying it to an oxygen burner-lance in an example of the present invention, and is a graph showing the relationship between a distance from a tip of an oxygen burner-lance and a melting time for cold iron sources.

### DETAILED DESCRIPTION OF THE PREFERRED EMBODIMENTS

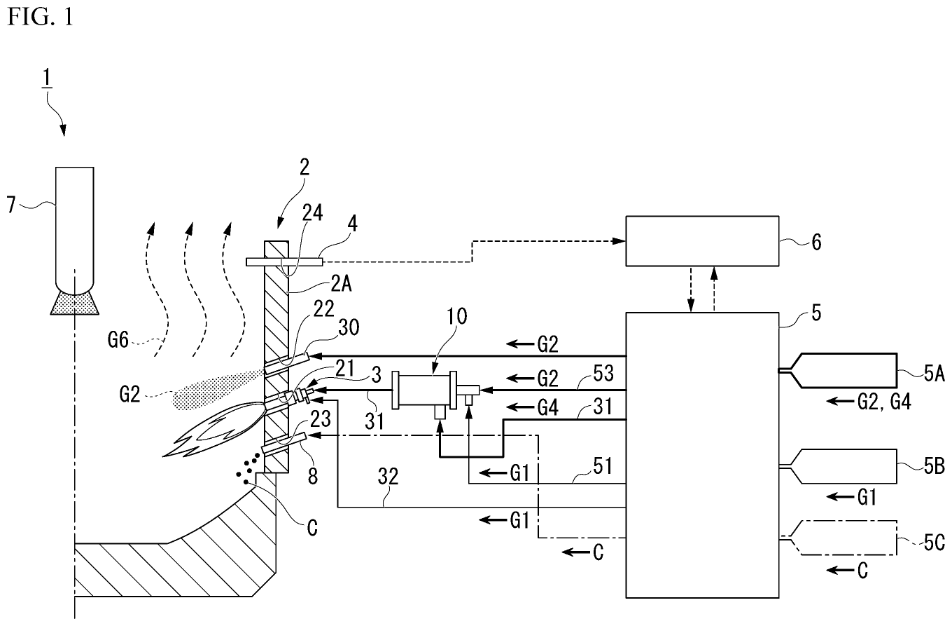

Hereinafter, a melting/refining furnace for cold iron sources and an operation method of a melting/refining furnace, which are embodiments according to the present invention, will be described with reference to FIGS. 1 to 3 as appropriate. In addition, in the drawings used in the following explanation, in order to make the features easier to understand, the characteristic portions may be enlarged for convenience, and the dimensional ratios of each component may not necessarily be the same as the actual ones. Also, although the materials and the like exemplified in the following description are merely examples, the present invention is not limited thereto, and can be implemented with appropriate modifications within the scope of the invention.

### <Configuration of Melting/Refining Furnace>

The configuration of the melting/refining furnace of the present embodiment will be described in detail below.

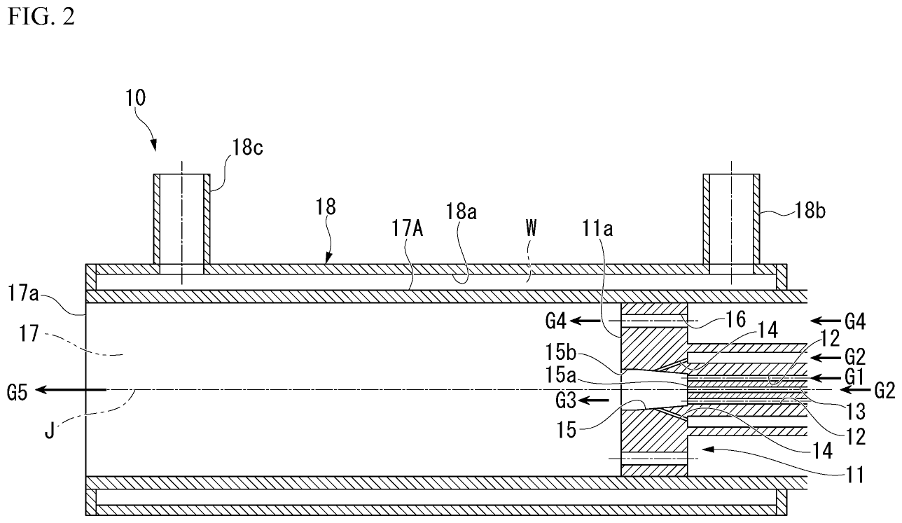

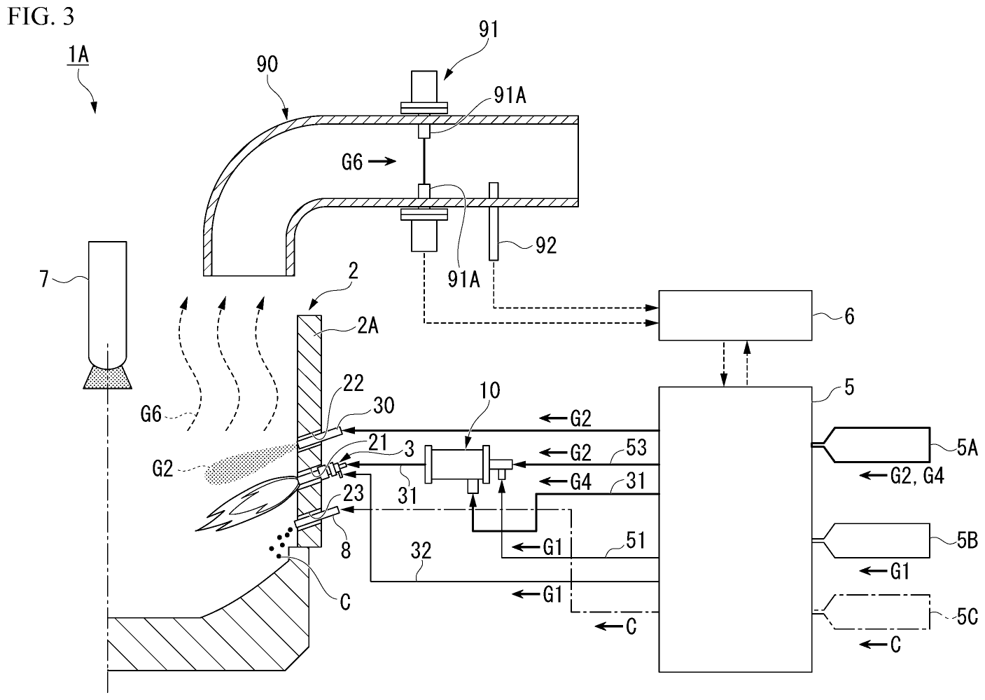

FIG. 1 is a schematic diagram showing the configuration of a melting/refining furnace 1 of the present embodiment, and is a system diagram showing each gas flow path. FIG. 2 is a sectional view showing the configuration of a high-temperature gas generator 10 provided in the melting/refining furnace 1 of the present embodiment. FIG. 3 is a system diagram showing another example of the gas flow path in the melting/refining furnace 1.

The melting/refining furnace 1 of the present embodiment includes an oxygen burner-lance 3 that ejects a combustion-supporting gas containing oxygen (high-temperature combustion-supporting gas G5) and a fuel gas G1 toward cold iron sources (not shown) housed in an electric furnace 2. As shown in FIG. 1, the melting/refining furnace 1 of the present embodiment includes the electric furnace 2 and the oxygen burner-lance 3 provided in a through-hole 21 so as to penetrate a furnace wall 2A.

The oxygen burner-lance 3 includes a combustion-supporting gas supply pipe 31 having an opening communicating with the inside of the electric furnace 2 and a fuel gas supply pipe 32 having an opening communicating with the inside of the electric furnace 2. The high-temperature gas generator 10 is provided in the path of the combustion-supporting gas supply pipe 31.

Further, the melting/refining furnace 1 shown in FIG. 1 includes a thermometer 4 for measuring the temperature inside the electric furnace 2. The thermometer 4 is electrically connected to a control board 6 by wireless connection or wired connection. Therefore, the amount of the combustion-supporting gas (high-temperature combustion-supporting gas G5) and fuel gas G1 supplied to the oxygen burner-lance 3 is controlled. The melting/refining furnace 1 shown in FIG. 1 also includes a flow rate control unit 5 for controlling the amount of the fuel gas G1, combustion-supporting gas G2, and a gas to be heated G4 supplied to the high-temperature gas generator 10.

In the illustrated example, a carbon supply source supply hole 23 for supplying carbon supply sources C to the electric furnace 2 is also provided.

Further, in the illustrated example, a combustion-supporting gas supply hole 22 is provided, which is provided so as to penetrate the furnace wall 2A above the through-hole 21 and supplies the combustion-supporting gas G2 containing oxygen for secondary combustion to the electric furnace 2.

According to the melting/refining furnace 1 of the present embodiment, the high-temperature combustion-supporting gas G5 generated in the high-temperature gas generator 10 can be supplied to the oxygen burner-lance 3 as the combustion-supporting gas.

The melting/refining furnace 1 of the present embodiment is a so-called electric furnace that melts and refines the cold iron sources in the furnace with an electrode 7. The through-hole 21 through which the oxygen burner-lance 3 is inserted, the combustion-supporting gas supply hole 22 through which a secondary combustion lance (oxygen lance) 30 is inserted, and the carbon supply source supply hole 23 through which a carbon lance 8 is inserted are provided so as to penetrate the furnace wall 2A of the electric furnace 2.

Although detailed illustration is omitted, a first combustion-supporting gas flow path that supplies the combustion-supporting gas containing oxygen (high-temperature combustion-supporting gas G5) to the furnace at the center (axial center) in the axial direction of the oxygen burner-lance 3 is provided, and a fuel flow path for supplying the fuel gas G1 to the furnace is provided concentrically on the outer peripheral side of the first combustion-supporting gas flow path. Further, a second combustion-supporting gas flow path is provided concentrically with the fuel flow path on the outer peripheral side of the fuel flow path, and a recirculating water cooling jacket is provided on the outermost layer on the outer peripheral side.

Alternatively, the recirculating water cooling jacket may be provided around the fuel flow path without providing the second combustion-supporting gas flow path. However, when the second combustion-supporting gas flow path is provided, the flame length can be finely adjusted by adjusting the oxygen flow rate ratio between the first combustion-supporting gas flow path and the second combustion-supporting gas flow path.

For example, the first combustion-supporting gas flow path may include, from the proximal side (the outside of the electric furnace 2 in FIG. 1) to the distal side (the inside thereof), a large-diameter portion having a constant inner diameter, a throat portion having an inner diameter smaller than that of the large-diameter portion, a widening portion in which the inner diameter gradually increases from the throat portion toward the tip side, and a linear motion portion having an almost constant inner diameter.

In addition, at the base end side of the first combustion-supporting gas flow path, that is, at the position on the outer peripheral of the electric furnace 2, in order to grasp the temperature of the cold iron sources in the electric furnace 2 in detail from the data near the oxygen burner-lance 3, for example, a radiation thermometer (not shown) may be provided. As such a radiation thermometer, it is also necessary to measure the temperature when the cold iron sources melt down, so it is desirable to install one that can measure a temperature range of, for example, about 600° C. to 2000° C. Specific examples of such a radiation thermometer include “IR-SA” manufactured by Chino Co., Ltd.

The oxygen burner-lance 3 is also connected to the flow control unit 5 that controls the amount of the fuel gas G1 and the combustion-supporting gas (high-temperature combustion-supporting gas G5) supplied to the oxygen burner-lance 3, as shown in FIG. 1 In the illustrated example, the oxygen burner-lance 3 is connected to the flow control unit 5 through a total of two pipes, the combustion-supporting gas supply pipe 31 to which combustion-supporting gas (high-temperature combustion-supporting gas G5) is supplied, and the fuel gas supply pipe 32 to which fuel gas G1 is supplied. Furthermore, in the illustrated example, the high-temperature gas generator 10 of which the details will be described later is provided on the path of the combustion-supporting gas supply pipe 31.

In the present embodiment, as the fuel gas G1 supplied to the oxygen burner-lance 3, for example, in addition to natural gas, gas that satisfies conditions such as being combustible, insoluble in water, and having a large calorific value per unit volume can be exemplified. Specifically, examples of the fuel gas G1 include liquefied petroleum gas (LPG), city gas, and gas containing hydrocarbons such as methane.

Further, examples of the combustion-supporting gas G2 supplied to the oxygen burner-lance 3 include oxygen-enriched air or oxygen.

A melting/refining furnace for cold iron sources can generally include about 3 or 4 oxygen burner-lances per furnace wall, depending on the size of the furnace.

One or more combustion-supporting gas supply holes 22 are provided through the furnace wall 2A above the through-hole 21 through which the oxygen burner-lance 3 is inserted, as described above. The secondary combustion lance 30 for supplying the combustion-supporting gas G2 containing oxygen for secondary combustion in the electric furnace 2 is inserted through the combustion-supporting gas supply hole 22.

The shape of the combustion-supporting gas supply hole 22 is not particularly limited. However, the shape of the combustion-supporting gas supply hole 22 is preferably such that when the furnace wall 2A is viewed in cross section, the combustion-supporting gas supply hole 22 expands at a predetermined angle from the outer peripheral side toward the inner peripheral side of the furnace wall 2A. As a result, the secondary combustion lance 30 can freely change the blowing direction of the combustion-supporting gas G2 in the vertical direction.

Although detailed illustration is omitted, the shape of the combustion-supporting gas supply hole 22 is preferably such that when the furnace wall 2A is viewed in planar view, the horizontal clearance is larger than the vertical clearance (for example, a racetrack shape and the like). This allows the secondary combustion lance 30 to freely change the blowing direction of the combustion-supporting gas G2 in the width direction.

Although detailed illustration is omitted in FIG. 1, in the secondary combustion lance 30, a reflux water cooling jacket is preferably provided around the combustion-supporting gas supply pipe that supplies the combustion-supporting gas containing oxygen.

As a result, if the combustion-supporting gas supply hole 22 is opened with an appropriate size, the secondary combustion lance 30 can be freely installed regardless of whether the furnace wall 2A is a refractory wall or a water-cooled wall.

Further, if the blowing direction of the secondary combustion lance 30 can be changed freely, it is possible to adjust the blowing direction of the combustion-supporting gas G2 in a direction that maximizes the secondary combustion effect depending on the flow of the discharged gas in the electric furnace 2.

The secondary combustion lance 30 is connected to a flow control unit 5 that controls the amount of the combustion-supporting gas G2 supplied to the secondary combustion lance 30, as shown in FIG. 1. Also, the flow rate control unit 5 is electrically connected to the control panel 6, and the control panel 6 is electrically connected to the thermometer 4. As a result, as the control signal based on the measurement result of the temperature inside the furnace by the thermometer 4 is sent from the control panel 6 to the flow control unit 5, it is possible to adjust the amount and the flow rate of the combustion-supporting gas G2 supplied to the electric furnace 2 via the secondary combustion lance 30.

One or more carbon supply source supply holes 23 are provided in the furnace wall 2A so as to pass through the furnace wall 2A at positions below the through-hole 21 through which the oxygen burner-lance 3 is installed. The carbon lance 8 for blowing (supplying) the carbon supply source C to the electric furnace 2 is inserted through the carbon supply source supply hole 23.

The carbon supply source C carried by a carrier gas (for example, nitrogen, air, oxygen-enriched air, oxygen, and the like) is supplied to the electric furnace 2 through the carbon lance 8 arranged in the carbon supply source supply hole 23. As a result, the carbon supply source C introduced to the molten steel of the cold iron sources reacts with the excess oxygen contained in the molten steel to generate CO gas and foams the slag, creating a so-called slag foaming state. As a result, the slag brings the arc in the electric furnace 2 to a submerged state, thereby improving the energy efficiency of the arc.

In addition, the carbon supply source C supplied from the carbon lance 8 to the electric furnace 2 can be used as the secondary heat source described above, or can be used for component adjustment for introducing carbon to molten steel.

Further, the carbon lance 8 is connected to a flow rate control unit 5 for controlling the amount of the carbon supply source C supplied to the carbon lance 8, as shown in FIG. 1. Also, as described above, the flow control unit 5 is electrically connected to the control panel 6, and the control panel 6 is electrically connected to the thermometer 4. As a result, a control signal based on the measurement result of the temperature inside the furnace by the thermometer 4 is sent from the control panel 6 to the flow rate control unit 5, and the amount of the carbon supply source C supplied to the electric furnace 2 via the carbon lance 8 is adjusted.

The electrode 7 is an electrode for performing heating-discharge in the electric furnace 2, and electrodes conventionally used in the relevant technical field can be used without any limitation.

The high-temperature gas generator 10 is provided on the path of the combustion-supporting gas supply pipe 31 for supplying the combustion-supporting gas from the oxygen burner-lance 3 to the electric furnace 2, as described above. As shown in FIGS. 1 and 2, the high-temperature gas generator 10 uses a direct combustion method to mix the high-temperature gas G3 and the gas to be heated G4 to generate the high-temperature combustion-supporting gas G5, and supplies the combustion-supporting gas G5 to the oxygen burner-lance 3 as a combustion-supporting gas. Here, the high-temperature combustion-supporting gas G5 in the present embodiment is, for example, a high-temperature gas containing oxygen at 100 to 800° C., and may be as high as about 1200° C. if necessary.

The high-temperature gas generator 10 includes a burner 11 that generates the high-temperature gas G3, and a pre-heating chamber 17 that is provided downstream of the burner 11 and mixes the high-temperature gas G3 and the gas to be heated G4.

The burner 11 includes a combustion chamber 15 that forms a flame with the fuel gas G1 and the combustion-supporting gas G2, a fuel flow path 12 that supplies the fuel gas G1 to the combustion chamber 15, a first combustion-supporting gas flow path 13 (combustion-supporting gas flow path) and a second combustion-supporting gas flow path 14 (combustion-supporting gas flow path) that supply the combustion-supporting gas G2 to the combustion chamber 15, and a gas to be heated flow path 16 that communicates with the pre-heating chamber 17 and supplies the gas to be heated (combustion-supporting gas) G4 toward the pre-heating chamber 17.

The illustrated high-temperature gas generator 10 further includes a cooling jacket 18 for cooling one or both of the burner 11 and the pre-heating chamber 17.

More specifically, as shown in FIG. 2, the burner 11 installed in the high-temperature gas generator 10 includes, as the combustion-supporting gas flow path, the first combustion-supporting gas flow path 13 arranged on the central axis J of the burner 11 and ejects the combustion-supporting gas G2 in the axial direction of the burner 11. The fuel flow path 12 is arranged around the first combustion-supporting gas flow path 13, i.e. outside with respect to the central axis J, and ejects the fuel gas G1 in the axial direction of the burner 11. Further, the burner 11 includes the second combustion-supporting gas flow path 14 arranged around the fuel flow path 12 and ejects the combustion-supporting gas G2 toward the central axis J side while being inclined in the gas ejection direction as the combustion-supporting gas flow path.

The fuel flow path 12, the first combustion-supporting gas flow path 13, and the second combustion-supporting gas flow path 14 open toward the combustion chamber 15. In the combustion chamber 15, a flame is formed by the fuel gas G1 ejected from the fuel flow path 12 and the combustion-supporting gas G2 ejected from the first combustion-supporting gas flow path 13 and the second combustion-supporting gas flow path 14.

Also, the gas to be heated flow path 16 communicates with the pre-heating chamber 17 and is arranged around the second combustion-supporting gas flow path 14. In the illustrated example, the gas to be heated flow path 16 opens toward the pre-heating chamber 17 and the gas to be heated G4 is supplied toward the pre-heating chamber 17 by blowing out the gas to be heated G4 from around the flame.

Although detailed illustration is omitted in FIGS. 1 and 2, the fuel flow path 12, the first combustion-supporting gas flow path 13, the second combustion-supporting gas flow path 14, and the gas to be heated flow path 16 provided in the high-temperature gas generator 10 are each connected to the flow control unit 5.

Specifically, the fuel flow path 12 is connected to the flow control unit 5 via a fuel flow path pipe 51. Also, the first combustion-supporting gas flow path 13 and the second combustion-supporting gas flow path 14 are connected to the flow control unit 5 via combustion-supporting gas flow path pipes 53. The gas to be heated flow path 16 is also connected to the flow control unit 5 via the combustion-supporting gas supply pipe 31. That is, the gas to be heated flow path 16 supplies the same gas as the combustion-supporting gas G2 toward the pre-heating chamber 17 as the gas to be heated G4.

Further, the combustion-supporting gas supply pipe 31 described above is connected to the downstream side of the pre-heating chamber 17 in the direction of gas flow, that is, to a tip 17a of the pre-heating chamber 17. The combustion-supporting gas supply pipe 31 is connected to the first combustion-supporting gas flow path 13 and/or the second combustion-supporting gas flow path 14 in the oxygen burner-lance 3 (not shown). That is, the combustion-supporting gas supply pipe 31 connected to the pre-heating chamber 17 supplies the high-temperature combustion-supporting gas G5 to the oxygen burner-lance 3 as a combustion-supporting gas for combustion.

As the fuel gas G1 supplied to the high-temperature gas generator 10, as in the case of the oxygen burner-lance 3, for example, in addition to natural gas, gas that satisfies conditions such as being combustible, insoluble in water, and having a large calorific value per unit volume can be exemplified. Specifically, examples of the fuel gas G1 include liquefied petroleum gas (LPG), city gas, and gas containing hydrocarbons such as methane.

Examples of the combustion-supporting gas G2 supplied to the high-temperature gas generator 10 also include oxygen-enriched air or oxygen, as in the case of the oxygen burner-lance 3.

Also, examples of the gas to be heated G4 supplied to the high-temperature gas generator 10 include oxygen-enriched air or oxygen, as in the case of the combustion-supporting gas G2. When oxygen gas (oxygen) is used as the gas to be heated G4, and the high-temperature combustion-supporting gas (oxygen gas) is supplied to the electric furnace 2, oxygen gas having an oxygen purity of, for example, 90% is preferably used as the gas to be heated G4.

As shown in FIG. 2, the burner 11 has the combustion chamber 15 which is substantially cylindrical and open so that a tip 11a side in the flame-forming direction is enlarged in diameter. By forming a flame in this combustion chamber 15, high-temperature gas G3 is generated.

In the illustrated example, the combustion chamber 15 is a substantially cylindrical recess having a side surface that expands toward the tip 11a and an open bottom on the tip 11a side. As described above, the burner 11 generates the flame in the combustion chamber 15, and generates the high-temperature gas G3 toward the downstream side of the burner 11, that is, the pre-heating chamber 17.

The combustion chamber 15 may have a constant inclination angle of a side wall 15b from a bottom 15a on the base end side to the tip 11a side. However, from the viewpoint of ensuring a stable flame, it is more preferable that a portion of the tip 11a side be cylindrical, as shown in the FIG. 2.

As explained above, the fuel flow path 12 is arranged outside the central axis J, that is, around the first combustion-supporting gas flow path 13, which will be detailed later, and ejects the fuel gas G1 in the axial direction of the burner 11.

The opening of the fuel flow path 12 is arranged so as to open to the bottom 15a of the combustion chamber 15, and the fuel gas G1 supplied from the fuel flow path 12 is ejected to the combustion chamber 15.

Although detailed illustration is omitted, for example, a plurality of fuel flow paths 12 are arranged in parallel at a regular interval on a circumference centered on the central axis J so as to surround the first combustion-supporting gas flow paths 13 provided on the central axis J.

The arrangement intervals, the number, the shape, and the like of the openings of the plurality of fuel flow paths 12 are not particularly limited as long as they are open toward the inside of the combustion chamber 15, and can be set arbitrarily.

The first combustion-supporting gas flow path (combustion-supporting flow path) 13 is arranged on the central axis J of the burner 11 and ejects the combustion-supporting gas G2 in the axial direction of the burner 11, as described above.

Similar to the fuel flow path 12, the opening of the first combustion-supporting gas flow path 13 is arranged to open to the bottom 15a of the combustion chamber 15, and ejects the combustion-supporting gas G2 supplied from the first combustion-supporting gas flow path 13 to the combustion chamber 15.

The shape of the opening of the first combustion-supporting gas flow path 13 is not particularly limited as long as it opens inside the combustion chamber 15, and can be arbitrarily designed.

The second combustion-supporting gas flow path (combustion-supporting gas flow path) 14 is arranged around the fuel flow path 12 and ejects the combustion-supporting gas G2 toward the central axis J side while being inclined with respect to the central axis J of the burner 11. That is, although detailed illustration is omitted, for example, a plurality of second combustion-supporting gas flow paths 14 are arranged at equal intervals on a circumference around the central axis J so as to surround the fuel flow path 12 while gradually inclining toward the central axis J toward the tip 11a of the burner 11. In the example shown in FIG. 1, the openings of the second combustion-supporting gas flow paths 14 are arranged so as to open to the side wall 15b of the combustion chamber 15.

The angle of the second combustion-supporting gas flow path 14 with respect to the central axis J, that is, the confluence angle of the combustion-supporting gas G2 ejected from the second combustion-supporting gas flow path 14 with respect to the fuel gas G1 ejected from the fuel flow path 12 and the combustion-supporting gas G2 ejected from the first combustion-supporting gas flow path 13 is not particularly limited.

However, in consideration of combustion efficiency, and the like, the confluence angle is preferably in the range of 10 to 30 degrees.

In addition, as long as the openings of the plurality of second combustion-supporting gas flow paths 14 are opened in the side wall 15b of the combustion chamber 15 as described above, the arrangement interval, the number, the shape, and the like are not particularly limited, and can be arbitrarily selected.

As described above, the gas to be heated flow path 16 is arranged around the second combustion-supporting gas flow path 14 and communicates with and opens inside the pre-heating chamber 17. In the example shown in FIG. 2, the gas to be heated flow path 16 is opened at the end surface of the tip 11a of the burner 11.

Although detailed illustration is omitted, for example, a plurality of gas to be heated flow paths 16 are arranged in parallel at a regular interval on a circumference centered on the central axis J so as to surround the second combustion-supporting gas flow path 14.

The gas to be heated flow path 16 is opened at the end surface of the tip 11a of the burner 11 to eject the gas to be heated G4 from around the flame and supply the gas to be heated G4 toward the pre-heating chamber 17. That is, the first combustion-supporting gas flow path 13 and the second combustion-supporting gas flow path 14 are flow paths through which the fuel gas G1 to be used for combustion flows, while the gas to be heated flow path 16 is a flow path through which the gas to be heated G4 flows. Therefore, the gas to be heated flow path 16 does not open to the combustion chamber 15 but opens to the pre-heating chamber 17.

As long as the opening of the heating gas flow path 16 opens to the pre-heating chamber 17, the arrangement interval, the number, the shape, and the like are not particularly limited, and can be set arbitrarily.

The pre-heating chamber 17 is provided downstream of the burner 11 and is a space for mixing the high-temperature gas G3 and the gas to be heated G4. The illustrated pre-heating chamber 17 is formed by a cylindrical tube 17A. By arranging the burner 11 inside the cylindrical tube 17A, the space between the burner 11 and the tip 17a of the cylindrical tube 17A becomes the pre-heating chamber 17.

The high-temperature gas G3 generated by the flame formed in the combustion chamber 15 of the burner 11 and the gas to be heated G4 supplied by the gas to be heated flow path 16 are supplied to the pre-heating chamber 17. The high-temperature combustion-supporting gas G5 is thereby generated in the pre-heating chamber 17. The generated high-temperature combustion-supporting gas G5 is supplied outward from the tip 17a side of the cylindrical tube 17A.

In addition, in the high-temperature gas generator 10 of the example shown in FIG. 1, the pre-heating chamber 17 is connected to the oxygen burner-lance 3 via the combustion-supporting gas supply pipe 31. Therefore, the pressure at each flow path outlet of the burner 11 depends on the specifications and settings of the oxygen burner-lance 3 side.

The cooling jacket 18 is for cooling the burner 11 or both the burner 11 and the pre-heating chamber 17. The illustrated cooling jacket 18 is provided so as to cool both of them. That is, the cooling jacket 18 is cylindrical, and has a double-tube structure covering the cylindrical tube 17A described above via an annular space. This annular space is a cooling water flow path 18a through which the cooling water W flows, and the burner 11 and the pre-heating chamber 17 can be cooled by the cooling water W flowing therethrough.

In the illustrated cooling jacket 18, the cooling water W is introduced from an inlet pipe 18b side, passes through the cooling water flow path 18a and is discharged from an outlet pipe 18c. In the high-temperature gas generator 10 of the present embodiment, when the cooling water W passes through the cooling water flow path 18a, both the burner 11 and the pre-heating chamber 17 can be cooled by cooling the burner 11 and the cylindrical tube 17A.

The cooling jacket 18 protects each component of the burner 11 from the high temperature atmosphere and radiant heat caused by the flame, and suppresses excessive heating in the combustion chamber 15.

Actions and effects obtained by the high-temperature gas generator 10 will be described.

When high-temperature gas G3 and the gas to be heated G4 are mixed to generate the high-temperature combustion-supporting gas G5, like the high-temperature gas generator 10 provided in the melting/refining furnace 1 of the present embodiment, pressure fluctuations in the high-temperature gas generator 10 tend to increase. When the pressure changes, the gas density changes even if the flow rate is the same, so the velocity of each gas to be ejected also changes (see also Patent Document 2 above).

In general, if the ejection speed of each gas ejected from the burner is slow, flashback occurs, or the jet flow is weak, so it is likely to be affected by external disturbances and misfire. On the other hand, if the ejection speed of each gas is too fast, the flame will float, and in this case too, misfires are likely to occur. Also, in a burner using oxygen gas, since the flame temperature exceeds 2000° C., it is necessary to provide appropriate protection so that the nozzle is not melted and damaged.

On the other hand, the burner 11 provided in the high-temperature gas generator 10 includes the combustion chamber 15 that forms the flame with the fuel gas G1 and the combustion-supporting gas G2, the fuel flow path 12 that supplies the fuel gas G1 to the combustion chamber 15, the first combustion-supporting gas flow path 13 and the second combustion-supporting gas flow path 14 that supply the combustion-supporting gas G2 to the combustion chamber 15, and the gas to be heated flow path 16 that supplies the gas to be heated G4 to the pre-heating chamber 17.

That is, in the high-temperature gas generator 10, the supply flow path of the oxygen gas is divided into the flow path of the combustion-supporting gas G2 used for combustion with fuel gas G1 (first combustion-supporting gas flow path 13 and second combustion-supporting gas flow path 14) and the flow path of the gas to be heated G4 used for mixing with high-temperature gas G3 after combustion (gas to be heated flow path 16), and the high-temperature gas generator 10 further includes the combustion chamber 15 arranged independently of the pre-heating chamber 17.

As a result, it is possible to prevent the flame formed by the fuel gas G1 and the combustion-supporting gas G2 from misfiring due to the flow of the gas to be heated G4 from the gas to be heated flow path 16. Furthermore, the gas to be heated flow path 16 through which the gas to be heated G4 that is not used for combustion flows is provided along the central axis J of the burner 11. Therefore, a cooling effect for the entire burner 11 can be obtained, and an effect of cooling and protecting the inner wall of the cylindrical tube 17A can also be obtained.

In addition, in the burner 11 provided in the high-temperature gas generator 10, the first combustion-supporting gas flow path 13 is arranged on the central axis J of the burner 11 and ejects the combustion-supporting gas G2 in the axial direction of the burner 11. Also, the fuel flow path 12 is arranged around the first combustion-supporting gas flow path 13 and ejects the fuel gas G1 in the axial direction of the burner 11. Furthermore, the second combustion-supporting gas flow path 14 is arranged around the fuel flow path 12, and ejects the combustion-supporting gas G2 so as to be directed toward the central axis J of the burner 11 while being inclined with respect to the central axis J.

In this way, the fuel gas G1 is sandwiched by the combustion-supporting gas G2 ejected from first combustion-supporting gas flow path 13 and second combustion-supporting gas flow path 14. As a result, the combustion state is stably maintained, and the side wall 15b and the bottom 15a of the combustion chamber 15 can be protected by the oxygen flow by the combustion-supporting gas G2 ejected from the second combustion-supporting gas flow path 14 so that the temperature does not rise too much.

In addition, the gas to be heated G4 is ejected from the gas to be heated flow path 16 in the axial direction around the flame formed in the combustion chamber 15, and the high-temperature gas G3 generated by the flame and the gas to be heated G4 are mixed in the pre-heating chamber 17. As a result, the oxygen is heated to a high temperature, that is, the high-temperature combustion-supporting gas G5 can be delivered toward the oxygen burner-lance 3 as the combustion-supporting gas.

For example, in a conventional high-temperature gas generator in which the fuel flow path is arranged in the center of the burner and the oxygen flow path is arranged around it, it is significantly difficult to maintain the flame when the ejection velocity of each gas is large. On the other hand, according to the high-temperature gas generator 10 provided in the melting/refining furnace 1 of the present embodiment, since the fuel flow path 12 is sandwiched by the first combustion-supporting gas flow path 13 and the second combustion-supporting gas flow path 14, the flame can be stably maintained even when the ejection speed of each gas is high.

Further, in the melting/refining furnace 1 of the present embodiment, the combustion-supporting gas flow path pipe 53 for supplying the combustion-supporting gas G2 (gas to be heated G4) toward the high-temperature gas generator 10, and the combustion-supporting gas supply pipe 31 are separated. Therefore, the gas flow rate of the first combustion-supporting gas flow path 13, the second combustion-supporting gas flow path 14, and the gas to be heated flow path 16 can be independently controlled. Thereby, the oxygen burner-lance 3 can be stably supplied with the high-temperature combustion-supporting gas G5.

However, the present embodiment is not limited to the configuration above. For example, the first combustion-supporting gas flow path 13, the second combustion-supporting gas flow path 14, and the gas to be heated flow path 16 may be connected as one gas flow path to the flow control unit 5, and then branched on the upstream side of the burner 11 and pre-heating chamber 17.

Moreover, when the high-temperature gas generator 10 is provided with the cooling jacket 18 as shown in the figure, the following effects can be obtained.

That is, by providing the cooling jacket 18, for example, the burner 11 and the cooling water W come into direct contact with each other, or the burner 11 and the cooling water W come into contact with each other via another structure (cylindrical tube 17A in the illustrated example). By coming into contact with each other, the burner 11 can be sufficiently cooled and prevented from melting. In addition, it is possible to prevent the burner 11 or the entire high-temperature gas generator 10 from being deformed or damaged due to thermal stress, and to minimize the occurrence of fatigue fracture due to repeated application of thermal stress, and thereby it is possible to extend the service life.

In the illustrated example, the cooling jacket 18 is provided so as to cover from the burner 11 to the pre-heating chamber 17, but is not limited to this embodiment. For example, the pre-heating chamber 17 may be protected by cooling only the burner 11 with the cooling jacket 18 and forming the inner wall of the cylindrical tube 17A with a refractory material.

Further, although detailed illustration is omitted in FIG. 2, the combustion-supporting gas G2 may be supplied from the same supply pipe to the first combustion-supporting gas flow path 13 and the second combustion-supporting gas flow path 14 of the burner 11 of the high-temperature gas generator 10. Furthermore, the combustion-supporting gas G2 may be supplied by different supply pipes from separate sources.

The thermometer 4 measures the temperature inside the electric furnace 2 and transmits the measured value to the flow rate control unit 5 via the control panel 6, the details of which will be described later.

As shown in FIG. 1, the thermometer 4 is inserted and installed in a temperature measurement hole 24 A which is formed so as to penetrate in the furnace wall 2A above the through-hole 21 through which the oxygen burner-lance 3 is inserted and the combustion-supporting gas supply hole 22 through which the secondary combustion lance 30 is inserted.

The thermometer 4 is not particularly limited, and thermometers conventionally used in this technical field can be used without any restrictions. For example, a thermometer in which a temperature range of about 600° C. to 2000° C. can be measured and has a high heat resistance can be preferably used. Examples of such a thermometer 4 include a thermocouple, a radiation thermometer, an infrared thermography (thermoviewer), a two-color thermometer, and the like.

Also, the method of transmitting the measured value data from the thermometer 4 to the outside is not particularly limited, and any method can be used as long as it can transmit the measured value to the control panel 6.

Also, the installation position of the thermometer 4 is not limited to the temperature measurement hole 24 provided in the furnace wall 2A as shown in the illustrated example, but can be any place at which the temperature inside the electric furnace 2 can be measured. For example, the thermometer 4 may be provided in the discharge passage for discharged gas (see reference numeral 90 in FIG. 3), which will be detailed later, and the temperature inside the electric furnace 2 may be estimated and grasped.

The flow rate control unit 5 controls the amount of the gases and the carbon supply source C, and the like supplied to the oxygen burner-lance 3, the high-temperature gas generator 10, and the electric furnace 2. That is, the flow control unit 5 receives a control signal from the control board 6 based on the temperature in the electric furnace 2 measured by the thermometer 4, and controls the amount of the combustion-supporting gas (high temperature combustion-supporting gas G5) and the fuel gas G1 supplied to the oxygen burner-lance 3, and also controls the amount of the fuel gas G1, the combustion-supporting gas G2, and the gas to be heated G4 supplied to the high-temperature gas generator 10. In addition, the flow control unit 5 controls the amount of the combustion-supporting gas G2 for secondary combustion supplied from the secondary combustion lance 30 to the electric furnace 2 and the amount the carbon supply source C supplied from the carbon lance 8 to the electric furnace 2, based on the temperature measured by the thermometer 4.

In addition, the flow control unit 5 can optionally control the amount of the fuel gas G1, the combustion-supporting gas G2, the gas to be heated G4, and the carbon supply source C based on the temperature of the cold iron sources housed in the electric furnace 2 measured by a radiation thermometer (not shown in figures) provided on the rear end side of the oxygen burner-lance 3.

In addition, the flow control unit 5 is connected with an oxygen supply source 5A for supplying oxygen gas as the combustion-supporting gas G2 and the gas to be heated G4, a fuel source 5B for supplying the fuel gas G1, and a carbon supply source 5C for supplying the carbon material (carbon supply source) in the electric furnace 2.

The control panel 6 is connected to the thermometer 4 as described above, and transmits a control signal to the flow rate control unit 5 based on the measured value of the temperature inside the electric furnace 2 measured by the thermometer 4.

As the control panel 6, a control device conventionally used in this field can be adopted without any restrictions.

According to the melting/refining furnace 1 of the present embodiment, the combustion-supporting gas supply pipe 31 connected to the oxygen burner-lance 3 is provided with the high-temperature gas generator 10 as described above. Therefore, the high-temperature combustion-supporting gas G5 heated by the high-temperature gas generator 10 can be supplied to the oxygen burner-lance 3 as the combustion-supporting gas.

More specifically, in the high-temperature gas generator 10, the gas to be heated G4 is heated by the high-temperature gas G3 to generate the high-temperature combustion-supporting gas G5, and the high-temperature combustion-supporting gas G5 is supplied to the oxygen burner-lance 3. As a result, a high-temperature flame can be generated from the oxygen burner-lance 3 toward the inside of the electric furnace 2. As a result, the cold iron sources housed in the electric furnace 2 can be efficiently heated, melted and refined without increasing the amount of the combustion-supporting gas supplied to the electric furnace 2. Therefore, the heating efficiency of the raw material can be improved without oxidizing the raw material due to excessive supply of the combustion-supporting gas. Thereby, it is possible to reduce the amount of power consumption required for melting the raw material, improve energy efficiency, and shorten the melting and refining time, which makes it possible to improve productivity and reduce costs.

Further, according to the present embodiment, the high-temperature combustion-supporting gas G5 generated by the high-temperature gas generator 10 can be introduced to the oxygen burner-lance 3. For example, depending on the conditions inside the furnace, it is possible to switch between multiple operation modes of the oxygen lance burner and adjust the combustion state. This makes it possible to heat, melt and refine cold iron sources more efficiently.

Moreover, in the high-temperature gas generator 10 in the present embodiment, the high-temperature combustion gas G5 is generated by mixing the high-temperature combustion gas (high-temperature gas G3) generated by the burner 11 and the gas to be heated G4 (combustion-supporting gas). Also, the flow control unit 5 adjusts the flow rates of the fuel gas G1, the combustion-supporting gas G2, and the gas to be heated G4 supplied to the high-temperature gas generator 10. As a result, when the operating conditions of the oxygen burner-lance 3 are adjusted according to the temperature conditions in the electric furnace 2, it is possible to control the temperature of the generated high-temperature combustion-supporting gas G5 by adjusting the flow rate of various gases supplied to the high-temperature gas generator 10.

In addition, in the melting/refining furnace 1 of the present embodiment, the method of igniting the burner 11 provided in the high-temperature gas generator 10 is not particularly limited. For example, it is possible to ignite by providing an ignition plug (not shown in figures) in the burner 11 of the high-temperature gas generator 10, energizing the ignition plug, and emitting sparks from a tip of a spare burner toward the combustion chamber 15 of the burner 11. In addition, it is possible to insert a pilot burner (not shown in figures) in the high-temperature gas generator 10, and energize to ignite the pilot burner, and ignite the burner 11 from the pilot burner.

Also, the high-temperature gas generator 10 provided in the melting/refining furnace 1 of the present embodiment is connected from outside the furnace to the oxygen burner-lance 3 attached to the furnace wall 2A of the electric furnace 2. Therefore, the high-temperature gas generator 10 is not exposed to a high-temperature atmosphere before ignition of the oxygen burner-lance 3. This makes it possible to supply the oxygen burner-lance 3 with the high-temperature combustion-supporting gas G5 adjusted to the optimum temperature condition.

Also, the melting/refining furnace of the present embodiment is not limited to the configuration of the melting/refining furnace 1 shown in FIG. 1. For example, like the melting/refining furnace 1A shown in FIG. 3, it is preferable to further include a discharge passage 90 for discharging a discharged gas G6 from the electric furnace 2, and a discharged gas analyzer 91 which is provided in the discharge passage 90 and measures at least one of the concentration of components in the discharged gas G6 and the flow rate of the discharged gas G6. Further, in the melting/refining furnace 1A shown in FIG. 3, a discharged gas thermometer 92 is further provided downstream of the discharged gas analyzer 91 in the discharge passage 90 for discharged gas. Further, the melting/refining furnace 1A shown in FIG. 3 and the melting/refining furnace 1 shown in FIG. 1 are different in that the discharged gas thermometer 92 is provided in the discharge passage 90 for discharged gas, so the furnace wall 2A of the electric furnace 2 is not provided with a thermometer, and the discharged gas thermometer 92 is electrically connected to the flow rate control unit 5 via the control panel 6 in the melting/refining furnace 1 shown in FIG. 3.

As in the example shown in FIG. 3, when the discharge passage 90 for discharged gas and the discharged gas analyzer 91 are provided, the flow control unit 5 receives measurements of the temperature of the discharged gas from the discharged gas thermometer 92 and measurements of the concentration of components of the discharged gas G6, and flow rate of the discharged gas G6 from the discharged gas analyzer 91. The flow control unit 5 is internally provided with a control device which analyzes each of these received data, and transmits a signal for controlling the amount of the combustion-supporting gas (high-temperature combustion-supporting gas G5) and fuel gas G1 supplied to the oxygen burner-lance 3, the amount of the fuel gas G1, the combustion-supporting gas G2, and the gas to be heated G4 supplied to the high-temperature gas generator 10, and the amount of the combustion-supporting gas G2 and the carbon supply source supplied to the electric furnace 2.

Since the discharged gas G6 generated from the electric furnace 2 contains a large amount of dust, pretreatment of the dust is important in the discharged gas analysis. Therefore, although detailed illustration is omitted, the primary side of the discharged gas analyzer 91 is preferably provided with a filter unit for removing dust in the discharged gas G6 and a sampling unit for sucking the discharged gas. In addition, the discharged gas analyzer 91 is electrically connected to the flow rate control unit 5 via the control panel 6, and can transmit records of the analysis results (component concentration and flow rate) of the discharged gas G6 to the flow rate control unit 5.

The discharged gas analyzer 91 is provided with a probe 91A for sampling the discharged gas so as to be exposed in the discharge passage 90 for discharged gas. Specifically, although detailed illustration is omitted in FIG. 3, the probe 91A includes a discharged gas sampling pipe for analyzing components of the discharged gas G6, such as CO, CO₂, H₂, O₂, H₂O, N₂, and the like, and a pitot tube for measuring the flow rate of the discharged gas. The probe 91A continuously sucks the discharged gas G6 during operation of the electric furnace 2, but is periodically purged by a purge unit (not shown in figures) in order to prevent clogging due to dust in the discharged gas G6. Further, since the probe 91A is placed in the high-temperature discharged gas G6, it is made of a highly heat-resistant alloy or ceramics. However, when considering wear due to high-temperature oxidation and damage due to thermal shock, it is more preferable that the probe 91A be provided with a water cooling jacket.

According to the melting/refining furnace 1A of the example shown in FIG. 3, the discharge passage 90 for discharged gas, the discharged gas analyzer 91, and the discharged gas thermometer 92 are provided, so that the conditions inside the electric furnace 2 can be grasped in more detail. That is, the conditions inside the electric furnace 2 can be grasped in detail based on the temperature and the flow rate of the discharged gas G6, and the concentration of the components of the discharged gas G6. Therefore, it is possible to melt and refine the cold iron sources more efficiently depending on the conditions inside the electric furnace 2 by controlling the flow rate of each gas supplied to the oxygen burner-lance 3 and each gas supplied to the high-temperature gas generator 10, and the amount of the combustion-supporting gas and the carbon supply source C supplied to the electric furnace 2 based on the measured values.

Specifically, for example, when the discharged gas G6 contains a large amount of combustible gas such as H₂, the combustible gas contained in the discharged gas G6 can be optimally combusted, contributing to the improvement of the heating efficiency of the cold iron sources by increasing the amount of the oxygen gas to be heated G3, which is a combustion-supporting gas containing oxygen, supplied to the high-temperature gas generator 10 and increasing the amount of the high-temperature combustion-supporting gas G5 supplied to the electric furnace 2.

On the other hand, if the amount of the combustible gas such as H₂ in the discharged gas G6 is small, and the amount of oxygen is too large, the molten steel will be peroxidized, and it may take time to adjust the composition of the molten steel. Therefore, for example, the flow rate of the high-temperature combustion-supporting gas G5 supplied to the electric furnace 2 is limited by limiting the flow rate of the oxygen gas to be heated G4 supplied to the high-temperature gas generator 10.

In addition, if the amount of combustible gas such as H₂ in the discharged gas G6 is small and it is desired to further promote the heating and melting of the cold iron sources, it is possible to accelerate heating and melting of the cold iron sources without increasing the amount of oxygen by further increasing the temperature of the high-temperature combustion-supporting gas G5 generated by the high-temperature gas generator 10.

<Operation Method of Melting/Refining Furnace>

Below, the operation method of the melting/refining furnace in the present embodiment will be explained in detail.

The operation method of the melting/refining furnace of the present embodiment (hereinafter sometimes simply referred to as “operation method”) is, for example, a method that can use the melting/refining furnace 1, 1A of the embodiment above, and is a method of ejecting the combustion-supporting gas G2 containing oxygen and the fuel gas G1 toward the cold iron sources in the electric furnace 2 using an oxygen burner-lance 3 to melt and refine the cold iron sources.

That is, the operation method of the present embodiment is a method, for example, that uses the melting/refining furnace 1 shown in FIG. 1, the combustion-supporting gas to be supplied to the oxygen burner-lance 3 is heated to a high temperature by the high-temperature gas generator 10 provided in the first combustion-supporting gas flow path 13 of the oxygen burner-lance 3 to produce the high-temperature combustion-supporting gas G5, the produced high-temperature combustion-supporting gas G5 is ejected toward the cold iron sources in the electric furnace 2, the amount of the combustion-supporting gas (high-temperature combustion-supporting gas G5) and the fuel gas G1 supplied to the oxygen burner-lance 3 is controlled based on the temperature in the electric furnace 2, and the operation of the oxygen burner-lance 3 is started or stopped.

Specifically, first, the temperature in the electric furnace 2 is measured by the thermometer 4 when cold iron sources, which are raw materials, are accommodated in the electric furnace 2. At this time, the control panel 6 determines that the temperature in the electric furnace 2 is “low”, and sends a signal that shows the temperature in the electric furnace 2 is low to the flow control unit 5, and the flow control unit 5 starts the operation (combustion) of the oxygen burner-lance 3.

Also, the discharged gas analyzer 91 measures the flow rate of the discharged gas G6 generated in the electric furnace 2 and the concentration of uncombusted gas contained in the discharged gas G6. Next, the combustion-supporting gas G2 containing oxygen necessary for combusting the uncombusted gas is supplied from the secondary combustion lance 30 installed in the combustion-supporting gas supply hole 22 toward the inside of the electric furnace 2. This allows the uncombusted gas contained in the discharged gas G6 to be combusted and the cold iron sources to be heated.

Moreover, by controlling the flow rate of the combustion-supporting gas G2 supplied to the electric furnace 2 so as to correspond to the amount of uncombusted gas generated, it is possible to supply the amount necessary for combustion in just the right amount.

Also, the flow rate control unit 5 grasps the melting state of the cold iron sources based on the temperature in the electric furnace 2 measured by the thermometer 4. Next, in order to make up for the lack of heat in the electric heating in the electric furnace 2, the gas to be heated containing oxygen gas G4 is heated to a high temperature by the high-temperature gas generator 10 to obtain the high-temperature combustion-supporting gas G5, and the obtained high-temperature combustion-supporting gas G5 is supplied to the oxygen burner-lance 3.

At this time, especially when the amount of the combustible gas such as H₂ in the discharged gas G6 is small, the amount of the fuel gas G1 and the combustion-supporting gas G2 supplied to the high-temperature gas generator 10 is increased, and the temperature of the high-temperature combustion-supporting gas G5 generated by the high-temperature gas generator 10 is further raised and supplied to the oxygen burner-lance 3. This facilitates heat melting of the cold iron sources without increasing the amount of oxygen.

Next, when the cold iron sources are melted, the control panel 6 determines that the temperature in the electric furnace 2 is “high” based on the temperature in the furnace sent from the thermometer 4, and the signal that shows the temperature in the electric furnace 2 is high is sent to the flow control unit 5, and the flow control unit 5 stops the operation (combust) of the oxygen burner-lance 3.

At this time, in order to remove carbon in the molten steel, it is possible to carry out decarburization by blowing oxygen to the molten steel from the oxygen burner-lance 3, for example. At the same time, the flow rate control unit 5 controls the supply of the carbon supply source C from the carbon lance 8 to the electric furnace 2, thereby creating a slag foaming state.

According to the operation method of the present embodiment above, the flow control unit 5 analyzes the conditions in the electric furnace 2 based on the measured temperature in the electric furnace 2, controls the amount of the combustion-supporting gas (high-temperature combustion-supporting gas G5) and the fuel gas G1 supplied to oxygen burner-lance 3, the amount of the fuel gas G1, the combustion-supporting gas G2 and the gas to be heated G4 supplied to the high-temperature gas generator 10, and the amount of the amount of the combustion-supporting gas G2 and the carbon supply source C supplied to the electric furnace 2, and starts or stops the combustion. As a result, it is possible to melt and refine the cold iron sources more efficiently by changing the operation (operation) pattern according to the conditions inside the electric furnace 2.

The operation method of the melting/refining furnace of the present embodiment is not limited to the method using the melting/refining furnace 1 shown in FIG. 1. For example, it may be the operation method of the melting/refining furnace 1A shown in FIG. 3 as described above.

That is, the operation method of the present embodiment may be an operation method in which the temperature of the discharged gas G6 discharged from the electric furnace 2, the concentration of components contained in the discharged gas G6, and the flow rate of the discharged gas G6 are measured, and based on these measured values, the amount of the combustion-supporting gas (high-temperature combustion-supporting gas G5) and the fuel gas G1 supplied to the oxygen burner-lance 3, and the amount of the fuel gas G1, the combustion-supporting gas G2 and the gas to be heated G4 supplied to the high-temperature gas generator 10 are controlled. Further, in the operation method of the present embodiment, it is possible to control the amount of the combustion-supporting gas G2 and carbon supply source C supplied to the electric furnace 2.

According to the operation method using the melting/refining furnace 1A, as described above, the flow control unit 5 can analyze and grasp in detail the conditions in the electric furnace 2 based on the temperature, the concentration of components, and the flow rate of the discharged gas G6 discharged from the electric furnace 2. Based on the analysis result, the flow rate control unit 5 controls the amount of the combustion-supporting gas (high-temperature combustion-supporting gas G5) and the fuel gas G1 supplied to the oxygen burner-lance 3, and the amount of the fuel gas G1, the combustion-supporting gas G2, and the gas to be heated G4 supplied to the high-temperature gas generator 10, and the amount of the combustion-supporting gas G2 and the carbon supply source C supplied to the electric furnace 2 are controlled to start or stop combustion. As a result, the cold iron sources can be melted and refined more efficiently by changing the operation pattern according to the conditions in the electric furnace 2, as described above.

The operation patterns of the oxygen burner-lance 3 in the operation method of the melting/refining furnace of the present embodiment include the following patterns (1) to (4), and it is possible to control with various patterns.

(1) A pattern in which a flame is formed by the combustion-supporting gas at room temperature and the fuel gas G1, and the inside of the electric furnace 2 is heated by the flame.

(2) A pattern in which the combustion-supporting gas at room temperature is ejected to the electric furnace 2.

(3) A pattern in which the high-temperature combustion-supporting gas G5 is ejected at a higher speed than the speed at room temperature.

(4) A pattern in which a flame is formed by the high-temperature combustion-supporting gas G5 and the fuel gas G1, and provides maximum energy to the cold iron sources.

Of the above patterns, (1) is a pattern using the oxygen burner-lance 3 as a normal oxygen burner. (2) is a pattern using the oxygen burner-lance 3 as a normal oxygen lance. For example, when the cold iron sources, which are raw materials for molten steel, are not melted, the oxygen burner-lance 3 functions as an oxygen burner to accelerate the melting of the cold iron sources. After the cold iron sources are melted, the oxygen burner-lance 3 functions as an oxygen lance to introduce oxygen while stirring the molten steel, making it possible to adjust the composition of the molten steel.

In addition, when it is desired to increase the heating power for the cold iron sources, as in pattern shown in (3) above, the oxygen burner-lance 3 is used as a high-speed high-temperature oxygen lance and the high-temperature combustion-supporting gas G5, which is the combustion-supporting gas heated by the high-temperature gas generator 10, is blown to the electric furnace 2 at high speed.

Furthermore, if the cold iron sources are not melted, and the heating and melting ability is desired to be improved, as in the pattern shown in (4) above, the oxygen burner-lance 3 is used as a high-speed, high-temperature oxygen burner to introduce a more powerful flame in the electric furnace 2.

Since the conditions in the electric furnace 2 often changes greatly depending on various conditions, having a plurality of operation patterns as shown in (1) to (4) above broadens the range of control and improves efficiency. This leads to excellent operation performance of a furnace.

When the oxygen burner-lance 3 is operated using the high-temperature combustion-supporting gas G5, compared with the case of operating an oxygen burner-lance using a conventional normal temperature combustion-supporting gas, the cold iron sources are heated and melted more, but the amount of the oxygen supplied itself is not increased, making it possible to suppress peroxidation of the molten steel.

The mechanism by which such action is obtained is not clear. However, this is thought to be because by heating the combustion-supporting gas containing oxygen (the gas to be heated) to a high temperature to produce the high-temperature combustion-supporting gas, the ejection speed of the high-temperature combustion-supporting gas from the oxygen burner-lance 3 is increased, and penetration of the gas to the cold iron sources is increased.

In addition, since the energy of the sensible heat of the oxygen contained in the high-temperature combustion-supporting gas is input to the cold iron sources, this point also contributes to the improvement of the heating efficiency of the cold iron sources.

<Effect>

As described above, according to the melting/refining furnace 1, 1A of the present embodiment, the high-temperature gas generator 10 is provided in the combustion-supporting gas flow path pipe 53 provided in the oxygen burner-lance 3, so that the combustion-supporting gas (the gas to be heated G4) to be supplied to the electric furnace 2 becomes the high-temperature combustion-supporting gas G5 heated by the high-temperature gas G3. In this way, by supplying the high-temperature combustion-supporting gas G5 heated by the high-temperature gas generator 10 to the electric furnace 2, the cold iron sources can be melted and refined efficiently without increasing the amount of the combustion-supporting gas (oxygen) supplied.

Therefore, it is possible to prevent the oxidation of the raw materials and to increase the heating efficiency of the raw materials; so while decreasing the amount of electricity required for melting raw materials, it is possible to shorten the melting and refining times, improve productivity, and reduce costs.

Also, according to the operation method of melting/refining furnace 1 in the present embodiment, the gas to be heated G4 is heated to a high temperature to produce the high temperature combustion-supporting gas G5, and the high temperature combustion-supporting gas G5 is ejected toward the cold iron sources in the electric furnace 2 to melt and refine the cold iron sources, based on the measured temperature in the electric furnace 2, the amount of the high-temperature combustion-supporting gas G5 and the fuel gas G1 supplied to the oxygen burner-lance 3 is controlled, and the combustion of the oxygen burner-lance 3 is started and stopped. Thereby, it is possible to effectively heat, melt and refine the cold iron sources without increasing the amount of the combustion-supporting gas containing oxygen supplied. Further, it is possible to melt and refine the cold iron sources more effectively based on the conditions in the electric furnace 2 by controlling the amount of the high-temperature combustion-supporting gas G5 and the fuel gas G1 supplied and starting or stopping the combustion.

Furthermore, according to the operation method of the melting/refining furnace 1A of the present embodiment, the combustion-supporting gas (the gas to be heated G4) is heated to a high temperature to produce the high-temperature combustion-supporting gas G5, and the produced high-temperature combustion-supporting gas G5 is ejected toward the cold iron sources in the electric furnace 2 to melt and refine the cold iron sources, the amount of the high-temperature combustion-supporting gas G5 and the fuel gas G1 supplied to the oxygen burner-lance 3, and the amount of the fuel gas G1, the combustion-supporting gas G2 and the gas to be heated G4 supplied to the high-temperature gas generator 10 are controlled based on the measured value of the temperature, the concentration of components, and the flow rate of the discharged gas G6 discharged from the electric furnace 2, and combustion of the oxygen burner-lance 3 is started and stopped. Even when such an operation method is employed, the cold iron sources can be efficiently heated, melted and refined without increasing the amount of the combustion-supporting gas containing oxygen supplied.

Therefore, according to the operation method of the melting/refining furnace 1, 1A of the present embodiment, it is possible to achieve both the prevention of oxidation of the raw material and the enhancement of the heating efficiency of the raw material. As a result, it is possible to shorten the melting/refining time while reducing the amount of power used to melt the raw materials, thereby improving productivity and reducing costs.

### Another Embodiment of the Present Invention

Although the preferred embodiments of the present invention have been described in detail above, the present invention is not limited to the embodiments above, and various modifications and changes can be made within the scope of the gist of the invention described in the claims.

For example, in the melting/refining furnace 1 shown in FIG. 1 and the melting/refining furnace 1A shown in FIG. 3, only one combustion-supporting gas supply hole 22 is provided above the through-hole 21 through which the oxygen burner-lance 3 is inserted. However, the present invention is not limited to this embodiment, and for example, a plurality of combustion-supporting gas supply holes 22 may be provided.

### EXAMPLES

Hereinafter, the melting/refining furnace and the operation method of a melting/refining furnace according to the present invention will be described in more detail by examples, but the present invention is not limited to the following examples.

In the example, the melting/refining furnace 1 shown in FIG. 1 was prepared for experiments. That is, in the present example, the effects of supplying the high-temperature combustion-supporting gas G5 to the oxygen burner-lance 3 were evaluated, and the time required to heat and melt an iron plate in the electric furnace 2 was confirmed.

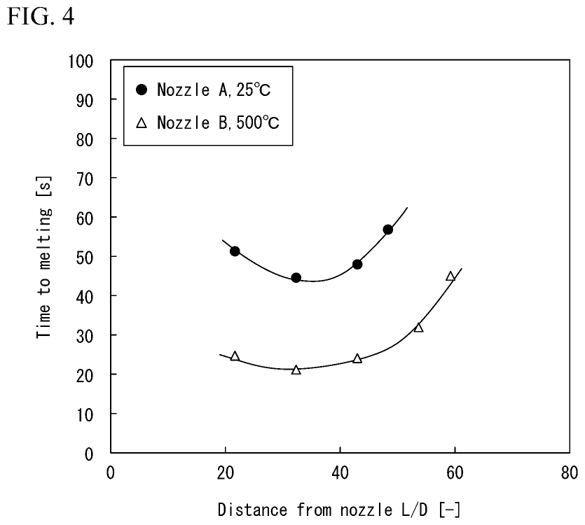

In the present example, as the oxygen burner-lance, a nozzle A for normal temperature and a nozzle B (oxygen burner-lance 3) for high temperature were used, and the time required to heat and melt the iron plate using these nozzles was compared. The results are shown in the graph of FIG. 4.

At this time, pure oxygen was used as the combustion-supporting gas, the combustion-supporting gas was supplied to the nozzle A at room temperature, and the combustion-supporting gas heated to 500° C. was supplied to the nozzle B as the high-temperature combustion-supporting gas from the high-temperature gas generator 10.

Also, the flow rate of the combustion-supporting gas was set to 200 Nm³/h, and the ejection speed was set to Mach 2.0.

In addition, natural gas was used as the fuel gas supplied to each nozzle (oxygen burner-lance), and the flow rate was set to 45 Nm³/h.

In addition, SS400 having a thickness of 3.2 mm was used as the iron plate to be heated and melted.

FIG. 4 is a graph showing the relationship between the distance {L/D} (mm) from the nozzle tip and the melting time (s) of the iron plate when the iron plate was heated and melted using the nozzle A and nozzle B. The distance {L/D} (mm) from the nozzle tip in FIG. 4 is a numerical value obtained by dividing the actual distance L (mm) from the nozzle tip by the inner diameter D (mm) of the nozzle.

As shown in the graph in FIG. 4, it can be seen that the melting time of the iron plate is significantly shortened by using the combustion-supporting gas heated to a high temperature.

### INDUSTRIAL APPLICABILITY

The melting/refining furnace for cold iron sources of the present invention does not oxidize the raw material, increases the heating efficiency of the raw material, reduces the power consumption required for melting the raw material, shortens the melting and refining time, improves productivity and achieves cost reduction.

Therefore, the melting/refining furnace of cold iron sources and the operation method of the melting/refining furnace of the present invention can be suitably used, for example, in a process using an electric furnace in the field of steelmaking to heat, melt and refine raw materials containing cold iron sources such as iron scraps in electric furnaces.

EXPLANATION OF REFERENCE NUMERALS

| | |
|---|---|
| 1, 1A | melting/refining furnace |
| 2 | electric furnace |
| 2A | furnace wall |
| 21 | through-hole |
| 22 | combustion-supporting gas supply hole |
| 23 | carbon supply source supply hole |
| 24 | temperature measurement hole |
| 3 | oxygen burner-lance |
| 31 | combustion-supporting gas supply pipe |
| 32 | fuel gas supply pipe |
| 30 | oxygen lance |
| 4 | thermometer |
| 5 | flow rate control unit |
| 5A | oxygen supply source |
| 5B | fuel supply source |
| 5C | carbon supply source |
| 51 | fuel flow path pipe |
| 53 | combustion-supporting gas flow path pipe |
| 6 | control panel |
| 7 | electrode |
| 8 | carbon lance |
| 90 | discharge passage for discharged gas |
| 91 | discharged gas analyzer |
| 91A | probe |
| 92 | discharged gas thermometer |
| 10 | high-temperature gas generator |
| 11 | burner |
| 11a | tip |
| 12 | fuel flow path |
| 13 | first combustion-supporting gas flow path |
| 14 | second combustion-supporting gas flow path |
| 15 | combustion chamber |
| 15a | bottom |
| 15b | side wall |
| 16 | gas to be heated flow path |
| 17 | pre-heating chamber |
| 17A | cylindrical tube |
| 17a | tip |
| 18 | cooling jacket |
| 18a | cooling water flow path |
| 18b | inlet pipe |
| 18c | outlet pipe |
| J | center axis |
| W | cooling water |
| G1 | fuel gas |
| G2 | combustion-supporting gas |
| G3 | high-temperature gas |
| G4 | gas to be heated |
| G5 | high temperature combustion-supporting gas |
| G6 | discharged gas |

1. A melting/refining furnace including an oxygen burner-lance for ejecting a combustion-supporting gas containing oxygen and a fuel gas toward cold iron sources in the furnace,
wherein the melting/refining furnace includes:
one or more through-holes provided to penetrate a furnace wall; and
an oxygen burner-lance provided in the through-hole,
wherein the oxygen burner-lance includes at least one combustion-supporting gas supply pipe having an opening communicating with an inside of the furnace and at least one fuel gas supply pipe having an opening communicating with an inside of the furnace, and
wherein a high-temperature gas generator is provided in any one or more of the combustion-supporting gas supply pipes.

2. The melting/refining furnace according to claim 1,
wherein the high-temperature gas generator includes:
a burner in which a high-temperature combustion-supporting gas is produced by mixing a high-temperature gas and a gas to be heated, the high-temperature combustion-supporting gas produced is supplied to the oxygen burner-lance as a combustion-supporting gas, and a high temperature gas is produced; and
a pre-heating chamber which is provided downstream of the burner in a flow direction of a gas ejected from the burner and mixes the high-temperature gas and the gas to be heated,
wherein the burner includes:
a combustion chamber in which a flame is produced by the fuel gas and the combustion-supporting gas;
a fuel flow path that supplies the fuel gas to the combustion chamber;
a combustion-supporting gas flow path that supplies the combustion-supporting gas to the combustion chamber; and
a gas to be heated flow path which communicates with the pre-heating chamber and supplies the gas to be heated toward the pre-heating chamber.

3. The melting/refining furnace according to claim 2,
wherein the high-temperature gas generator further includes a cooling jacket which cools the burner or both the burner and the pre-heating chamber.

4. The melting/refining furnace according to claim 2,
wherein the melting/refining furnace further includes:
a thermometer that measures the temperature in the furnace; and
a flow control unit that is electrically connected to the thermometer, and based on the temperature in the furnace measured by the thermometer, controls an amount of the combustion-supporting gas and the fuel gas supplied to the oxygen burner-lance, and an amount of the fuel gas, the combustion-supporting gas, and the gas to be heated to the high-temperature gas generator.

5. The melting/refining furnace according to claim 2,
wherein the melting/refining furnace further includes:
a discharge passage which discharges a discharged gas from inside of the furnace;
a discharged gas analyzer which is provided in the discharge passage for discharged gas and measures at least one of a concentration of components contained in the discharged gas and the flow rate of the discharged gas;
a discharged gas thermometer which is provided in the discharge passage for discharged gas downstream of the discharged gas analyzer in a flow direction of the discharged gas and measures the temperature of the discharged gas; and
a flow rate control unit which receives a measured value of the temperature of the discharged gas from the discharged gas thermometer, and a measured value of the concentration of components and the flow rate of the discharged gas from the discharged gas analyzer, analyzes these measured values, and controls an amount of the combustion-supporting gas and the fuel gas supplied to the oxygen burner-lance and an amount of the fuel gas, the combustion-supporting gas, and the gas to be heated to the high-temperature gas generator.

6. The melting/refining furnace according to claim 1,
wherein the combustion-supporting gas is oxygen gas or oxygen-enriched air.

7. The melting/refining furnace according to claim 2,
wherein the gas to be heated supplied to the high-temperature gas generator is oxygen gas.

8. An operation method of a melting/refining furnace in which a combustion-supporting gas containing oxygen and a fuel gas are ejected toward cold iron sources in the furnace using an oxygen burner-lance, and the cold iron sources are melted and refined,
wherein the operation method includes:
a step in which a combustion-supporting gas is heated to a high temperature by a high-temperature gas generator provided in a combustion-supporting gas supply pipe in an oxygen burner-lance to obtain a high-temperature combustion-supporting gas;
a step in which the high-temperature combustion-supporting gas is ejected toward the cold iron sources in the furnace as a combustion-supporting gas; and
a step in which, based on a measured temperature in the furnace, an amount of the combustion-supporting gas and the fuel gas supplied to the oxygen burner-lance is controlled, and combustion of the oxygen burner-lance is started and stopped.

9. An operation method of a melting/refining furnace in which a combustion-supporting gas containing oxygen and a fuel gas are ejected toward cold iron sources in the furnace using an oxygen burner-lance, and the cold iron sources are melted and refined,
wherein the operation method includes:
a step in which a combustion-supporting gas is heated to a high temperature by a high-temperature gas generator provided in a combustion-supporting gas supply pipe of an oxygen burner-lance to obtain a high-temperature combustion-supporting gas;
a step in which the high-temperature combustion-supporting gas is ejected toward the cold iron sources in the furnace as a combustion-supporting gas; and
a step in which, based on measured values of a temperature of a discharged gas discharged from inside of the furnace, the concentration of components contained in the discharged gas, and the flow rate of the discharged gas, an amount of the combustion-supporting gas and the fuel gas supplied to the oxygen burner-lance, and an amount of the fuel gas, the combustion-supporting gas and a gas to be heated to the high-temperature gas generator are controlled, and the combustion of the oxygen burner-lance is started and stopped.
